(19) United States
(12) Patent Application Publication
(10) Pub. No.: US 2013/0020435 A1
(43) Pub. Date: Jan. 24, 2013

(54) DATA ACQUISITION SYSTEM AND APPARATUS

(71) Applicant: Mamode Ufomata, Windsor, CT (US)

(72) Inventor: Mamode Ufomata, Windsor, CT (US)

(21) Appl. No.: 13/184,991

(22) Filed: Jul. 18, 2011

(51) Int. Cl. B64D 47/00; B64D 25/10

(52) U.S. Cl. 244/1 R

(57) ABSTRACT

A data acquisition system comprising: an aircraft ejectable seat; a flight data recorder removeably attached to the ejectable seat; a data connector in signal communication with the flight data recorder, and configured to removeably connect to an aircraft's data bus. A data acquisition apparatus comprising: a flight data recorder; a data connector in signal communication with the flight data recorder, and configured to removeably connect to an aircraft's data bus; and where the flight data recorder is configured to removeably attach to an ejectable aircraft seat.

### TECHNICAL FIELD

The present invention is directed to an apparatus and system for the preservation and recovery of data. More particularly, the invention relates to a system and device that is attached to an ejector seat.

### BACKGROUND

All vehicles operating on land, sea or air are potentially subject to catastrophic events that may lead to the destruction and/or disablement of the vehicle, such as crashes by way of non-limiting example. To determine the causes of these crashes some vehicles, for example aircraft and spacecraft, include instruments for recording operating data associated with the moving host vehicle. For example, a flight data recorder is typically installed in an aircraft for recording flight information and critical events leading up to a crash. The flight data recorder is configured to be recoverable in the event of an accident to determine what caused the crash. In addition to the flight data recorder, an aircraft also may include other recorders such as a cockpit voice recorder and a cockpit image recorder for recording sounds and activities that occur in the cockpit of the airplane. Presently, flight data recorders are often attached to the airframe of the airplane and therefore crash along with the airplane.

Each of these recording instruments is designed to survive a crash and is made of strong durable materials with heat protection. However, depending on the impact associated with the crash, one or more of these recording instruments may be damaged during the crash and may require repairs before useful or relevant information can be obtained. Even if no recording instrument is destroyed, the instruments must still be found after a crash in order to recover the recorded data. This can be a problem in a crash where the debris from the crash may be unrecoverable, for example, at the bottom of an ocean. Although these recording instruments may include location indicators, for example broadcast beacons that are used to indicate the location the recording instrument, the location indicators may not work in certain extreme terrains, such as the bottom of an ocean.

In those situations where one or all of the recording instruments are unrecoverable, it may be quite difficult, and in some cases impossible, to determine the cause of a crash. This may result in various consequences, human and commercial, and, for example, may delay remediation of safety issues, determination of negligence and/or fault, and resolution of the foregoing including insurance issues.

Therefore, there is a need for a data acquisition system and apparatus that overcomes the above and other disadvantages

### SUMMARY

The disclosed invention relates to a data acquisition system comprising: an aircraft ejectable seat; a flight data recorder removeably attached to the ejectable seat; a data connector in signal communication with the flight data recorder, and configured to removeably connect to an aircraft's data bus.

The disclosed invention also relates to a data acquisition apparatus comprising: a flight data recorder; a data connector in signal communication with the flight data recorder, and configured to removeably connect to an aircraft's data bus; and where the flight data recorder is configured to removeably attach to an ejectable aircraft seat.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic view of the disclosed system;

FIG. 2 is a schematic view of the disclosed system, with the ejectable seat being ejected;

FIG. 3 is a schematic view showing the ejectable seat after being ejected; and

FIG. 4 is a perspective view of an ejectable seat with the disclosed apparatus attached to it.

### DETAILED DESCRIPTION

This document discloses a data acquisition system (memory storage device that logs data such as, but not limited to engine and/or airplane data) that is attached to a pilot's ejector seat so that the data acquisition system ejects along with the seat in the case of an engine mishap or loss of aircraft situation. The data acquisition system can either be connected directly to the airplane's data bus as the primary data acquisition system or it can be attached to another data acquisition system as a secondary or back-up acquisition system.

The data acquisition system may be tied directly to any part of the pilot's ejector seat and possess a mechanism that will disconnect it from the airplane's data bus during an eject scenario. The data acquisition system can be any data acquisition or computing device designed to attach or strap to the ejector seat by a fitting mechanism, so as to keep the device attached or strapped to the ejector seat until when the operator decides to disconnect it. The data acquisition system may connect to the data bus by a connector that allows the acquisition system's cabling to meet the acceptable industry data bus wiring specification guidelines, such as the guidelines specified in MTL-STD-1553 (All revisions) or MIL-STD-1773 (All revisions). The commonly applied connector specifications that meet this requirement include and are not limited to MIL-C-39012 (RF coaxial connectors BNC, TNC), MIL-C-49142 (concentric twinax/triax connectors) and MIL-DTL-38999 (military type cylindrical connectors). The connector used can be a standard off the shelf connector or a custom designed connector, as long as it allows the data acquisition system to disconnect from the data bus during an ejection scenario. This will improve the chances of saving the data acquisition system as opposed to allowing the system to crash along with the airplane.

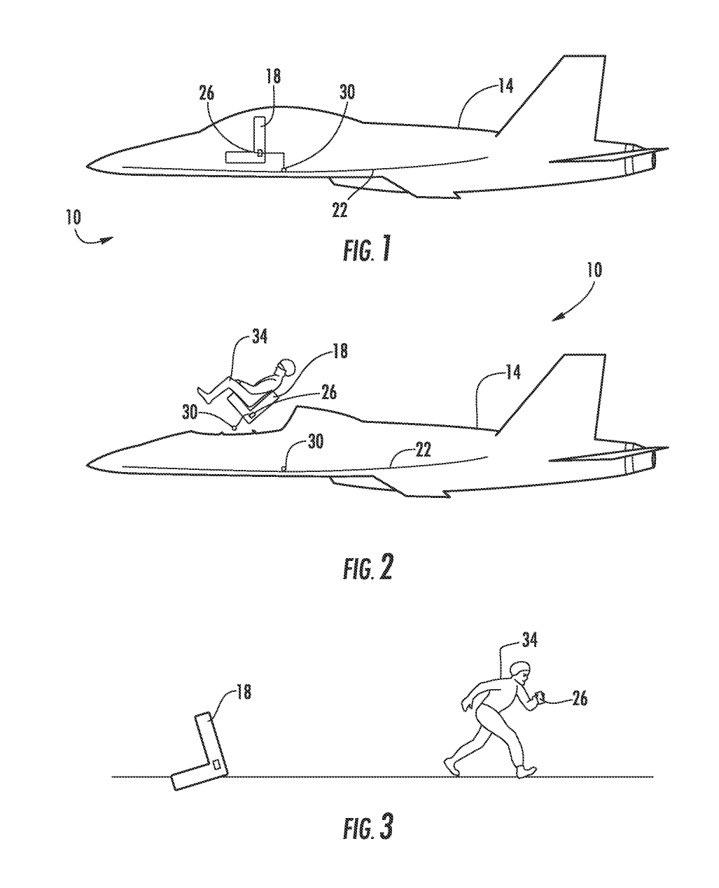

FIG. 1 shows a schematic view of one embodiment of the disclosed data acquisition system 10. In this view an aircraft 14 is shown with an ejectable seat 18 located within the aircraft 14. The ejectable seat 18 may be a system designed to rescue the pilot or other crew of an aircraft (often military) in an emergency. In many designs, the seat is propelled out of the aircraft by an explosive charge or rocket motor, carrying the pilot with it. The concept of an eject-able escape capsule is also included in the meaning of an “ejectable seat” in this document. Once clear of the aircraft, the ejection seat may deploy a parachute. The aircraft 14, as most aircraft, will have a data bus or data network 22. The data bus 22 allows components in various locations on the aircraft 14 to communicate with one another. Attached to the ejectable seat is a flight data recorder 26. This flight data recorder 26 may be the aircraft's primary data recorder, or, it may be a back-up or secondary data recorder. The flight data recorder commonly referred to as a “black box” 26 is an electronic device designed to record any information sent to or from a device on an aircraft. It may comprise a memory device, a processor for computing and interpreting data as well as software to monitor and/or control the protocol (e.g. ARINC) for receiving and transmitting information to and from the data bus. Some common names for data recorders include “black box”, Flight Data Recorder (FDR) and Flight Data Requisition Units (FDRU). Some common examples include but are not limited to Allied Signal Solid State Flight Data Recorder (e.g. model IACV01P05_{—}16) or the L-3 Solid State Flight Data Recorder (e.g. model numbers S603-1000-00, S703-1000-00 and S800-3000-00) or the L-3 Light weight Data Recorder (e.g. model number MKT059). The flight data recorder 26 is in signal communication with the data bus 22 via a connector 30. The connector 30 is configured to release the connection between the data bus 22 and the flight data recorder 26 in the event of the ejection of the ejectable seat 18. The connector 30 that may be used include, but are not limited to: RF coaxial connectors, concentric twinax/triax connectors, military type cylindrical connectors, D sub connectors, ARINC 404 connectors and ARINC 600 connectors. Whatever connector used most be able to disconnect during an ejection scenario.

FIG. 2 shows the ejectable seat 18 being ejected from the aircraft 14. A pilot (or other aircraft crewmember) 34 may be seated in the seat 18. The flight data recorder 26 is attached to the ejectable seat 26 and leaves the aircraft 14 along with the seat 18 and pilot 34. The connector 30 releases the connection between the flight data recorder 26 and the data bus 22 during the ejection of the seat 26.

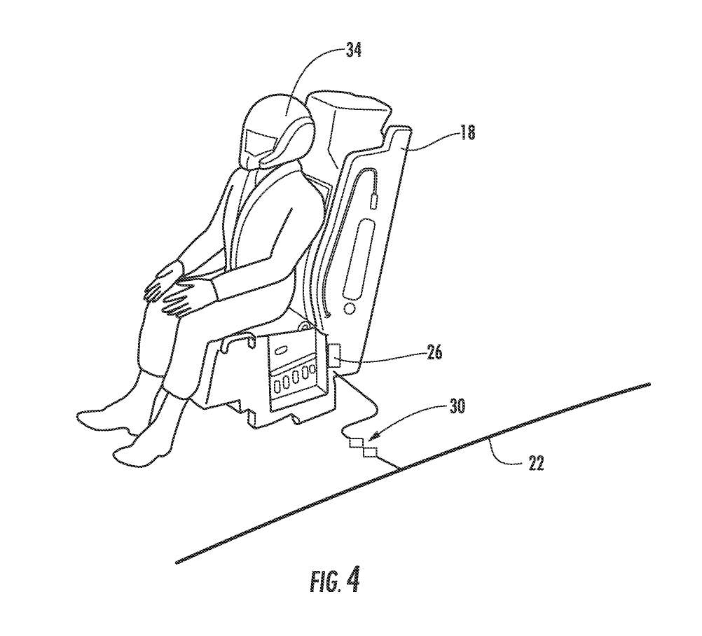

FIG. 3 FIG. 3 shows the ejectable seat 18 after it has landed. The pilot 34 is shown leaving the seat 18 with the flight data recorder 26. The flight data recorder 26 may removeably attachable to the seat 18. Further, the flight data recorder 26 and/or ejectable seat 18 may have a quick disconnect mechanism that allows it to be quickly disconnected from the seat.

FIG. 4 is a perspective view of an ejectable seat 18 with a pilot 34 sitting in it. The flight data recorder 26 is shown attached to the seat 18. One of ordinary skill in the art will recognize that the flight data recorder 26 may be attached to any suitable location on the seat 18.

In one embodiment, the data recorder may be portable like the L-3 Light weight Data Recorder (e.g. model number MKT059) described in the detailed description section. This would allow an operator easily carry the device after an ejection scenario. The data logger may be attached to the ejector seat by an easy disconnect mechanism (e.g. a strap and release buckle mechanism, or a pouch attached to the seat that will hold the data recorder) and the data logger may be connected to the data bus by a connector that would dislodge from the data bus during an ejection scenario (e.g. D sub 50 pin connector or an unrestrained Coaxial BNC connector).

The disclosed invention has many advantages. One advantage is that the flight data recorder will be ejected with the ejectable seat and not destroyed with the aircraft. Another advantage is that the flight data recorder may be disconnected from the ejectable seat, and taken by the pilot, crewmember, or other interested parties after (or before) ejection. In still another advantage, the flight data recorder need not be as rugged and impact and damage resistant as a flight data recorder that is attached to the airframe. Also the invention may greatly improve the ability to retrieve information from a downed plane especially in a conflict zone. Presently downed planes in conflict zones are fired upon and destroyed in order to keep sensitive technologies away from enemy combatants. This means that a data recorder attached to the airframe also gets destroyed thus destroying all that plane and reconnaissance information. With this application you avoid that loss of data.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof Therefore, it is intended that the disclosure not be limited to the particular embodiments disclosed as the best mode contemplated for carrying out this disclosure, but that the disclosure will include all embodiments falling within the scope of the appended claims.

1. A data acquisition system comprising:
an aircraft ejectable seat;
a flight data recorder removeably attached to the ejectable seat;
a data connector in signal communication with the flight data recorder, and configured to removeably connect to an aircraft's data bus.

2. The data acquisition system of claim 1, further comprising:
a quick disconnect means, attaching the flight data recorder to the ejectable seat.

3. The data acquisition system of claim 1, further comprising:
an aircraft data bus in signal communication with the flight data recorder via the data connector.

4. The data acquisition system of claim 1, further comprising:
an aircraft, removably attachable to the ejectable seat, and housing the aircraft data bus.

5. The data acquisition system of claim 1, wherein the flight data recorder comprises:
a memory device;
a processor for computing and interpreting data in signal communication with the memory device;
software to monitor and/or control the protocol for receiving and transmitting information to and from the data bus, the software loaded onto the memory device.

6. The data acquisition system of claim 1, wherein the flight data recorder is selected from the group consisting of the Allied Signal Solid State Flight Data Recorder model IACV01P05_{—}16, the L-3 Solid State Flight Data Recorder model number S603-1000-00, the L-3 Solid State Flight Data Recorder model number S703-1000-00, the L-3 Solid State Flight Data Recorder model number S800-3000-00, the L-3 Light weight Data Recorder model number MKT059.

7. The data acquisition system of claim 1, wherein the data connector is selected from the group consisting of an RF coaxial connectors, a concentric twinax/triax connector, a military type cylindrical connector, D sub connector, ARINC 404 connector, and ARINC 600 connector.

8. The data acquisition system of claim 2, wherein the quick disconnect means is a strap and release buckle mechanism.

9. A data acquisition apparatus comprising:
a flight data recorder;
a data connector in signal communication with the flight data recorder, and configured to removeably connect to an aircraft's data bus; and
wherein the flight data recorder is configured to removeably attach to an ejectable aircraft seat.

10. The data acquisition apparatus of claim 9, further comprising:
a quick disconnect means attached to the flight data recorder, and configured to allow for a quick disconnect of the flight data recorder from an ejectable aircraft seat.

11. The data acquisition apparatus of claim 9, wherein the flight data recorder comprises:
a memory device;
a processor for computing and interpreting data in signal communication with the memory device;
software to monitor and/or control the protocol for receiving and transmitting information to and from the data bus, the software loaded onto the memory device.

12. The data acquisition apparatus of claim 9, wherein the flight data recorder is selected from the group consisting of the Allied Signal Solid State Flight Data Recorder model IACV01P05_{—}16, the L-3 Solid State Flight Data Recorder model number S603-1000-00, the L-3 Solid State Flight Data Recorder model number S703-1000-00, the L-3 Solid State Flight Data Recorder model number S800-3000-00, the L-3 Light weight Data Recorder model number MKT059.

13. The data acquisition system of apparatus 9, wherein the data connector is selected from the group consisting of an RF coaxial connectors, a concentric twinax/triax connector, a military type cylindrical connector, D sub connector, ARINC 404 connector, and ARINC 600 connector.

14. The data acquisition system of claim 10, wherein the quick disconnect means is a strap and release buckle mechanism.
